(19) United States
(12) Patent Application Publication
(10) Pub. No.: US 2017/0345104 A1
(43) Pub. Date: Nov. 30, 2017

(54) Dynamic Identification of Businesses Based on Geo-Business Localized Social Signals

(71) Applicant: HERE Global B.V., Eindhoven (NL)

(72) Inventor: Kottorage Buddika Gajapala, Naperville, IL (US)

(21) Appl. No.: 15/163,905

(22) Filed: May 25, 2016

(51) Int. Cl. G06Q 50/00; G06F 17/30

(52) U.S. Cl. CPC G06Q 50/01; G06F 17/30867

(57) ABSTRACT

Web based business page data is received. Historical data for the web based business page data is compounded. Geo-business cells are generated based on business identification information. Relevancy values of each geo-business cell is determined based on historical data specific to the geo-business cell. Relevancy values associated with web based business pages are compared to the relevancy value of each respective geo-business cell. A group of businesses having web based pages with relevancy values above the relevancy value of the geo-business cell are identified.

### FIELD

The following disclosure relates to the identifying businesses via social media data, and more particularly, to the dynamic identification of businesses based on geo-business localized social signals.

### BACKGROUND

Social websites gather information about entities such as individuals, places, groups, and businesses. These entities (e.g., users) may further interact via the social websites. Social websites may generate, update, and maintain data associated with its users, on the order of over one hundred million data records per day.

Each entity may be registered with the social websites and associated with a page or user accounts. User accounts may be commercial user accounts (e.g., a business user account) or non-commercial user accounts (e.g., an individual). Commercial user accounts may represent a variety of business types. These businesses may be associated with one or more physical locations, fake locations, private or limited access places or events, temporary places, online entities with no physical presence, or an individual offering goods or services. Businesses having physical locations that are identified by specific geographic location and/or geographic regions (e.g., restaurants, hotels, shopping malls, and attractions). A business with a fake location may be an entity on a social website that appears to be associated with a geographic place but is not tied to any existing physical place (e.g., such as a fictitious town, a fantasy or science-fiction based location, a business or location in a game, virtual locations, etc.). Private or limited access places or events may include clubs, associations, events (such as a birthday party, wedding, or promoted event), groups, and the like. Businesses with temporary places may include lemonade stands, exhibition booths, stalls at a farmer's market. Individual businesses may include mobile businesses, such as a food truck or mobile heath care truck as well as individuals that provide services on-site to a customer such as a babysitter, repair service, or locksmith.

### SUMMARY

In one embodiment, a method of identifying businesses based on geo-business localized social signals is provided. Data indicative of social media pages is received. Each web based page is associated with the business, and the received data includes social signals associated with respective web based pages and business identification information. The method also compounds historical received data for each web based page based on the social signals associated with a respective web based page, and a plurality of geo-business cells is generated. Web based pages within each geo-business cell include web based pages with associated identification information. A relevancy value of each geo-business cell is determined based on historical data for web based pages of each respective geo-business self. The method also compares a relevancy value associated with individual web based pages of each geo-business cell to the relevancy value of each respective geo-business cell. The method identifies businesses having web based pages with relevancy values above the relevancy value of the geo-business cell.

In one embodiment, a method of providing dynamically updated business mapping based on geo-business localized social signals is provided. The method periodically receives data associated with web based pages for businesses. The received data includes social signals associated with the web based pages and business identification information. The method also compounds historical received data for each web based page based on the social signals associated with the respective web based page within a most recent number of periods, and geo-business cells are generated that include web based pages having associated business identification information. The method further determines a relevancy value of each geo-business cell based on historical data for web based pages of each respective geo-business. A relevance value associated with each web based page compared to the relevancy value for the respective geo-business cell. A currently relevant group of businesses is identified, each currently relevant business having web based pages with relevancy values above the relevancy value of the geo-business cell based on the historical received data over the most recent number of periods. The method further provides the currently relevant group businesses for display on a map.

In yet another embodiment, an apparatus for identifying businesses based on geo-business localized social signals is provided. The apparatus includes at least one processor and at least one memory including computer program code for one or more programs. The at least one memory and the computer program code configured to, with the at least one processor, cause the apparatus to periodically receive data for web based pages of businesses. The received data include social signals associated with respective web based pages and business identification information. The computer program code and processor may further cause the apparatus to filter received data based on business identification information including both business location information and business category information; historical received data is compounded for each web based page based on the social signals of the web based page during the most recent number of periods. The computer program code and processor may further cause the apparatus to generate your business cells for web based pages with matching business location information and matching business category information, and the apparatus determines a relevancy value of each business cell based on historical data for web based pages in the geo-business cell. The computer program code and processer also cause the apparatus to compare the relevancy value of individual pages to the relevancy value of the respective geo-business cell; identify a currently relevant group of businesses that have web based pages with relevance values above the relevancy value for the geo-business cell based on the most recent number of periods of the historical received data; and provide the currently relevant group of businesses for display on a map.

### BRIEF DESCRIPTION OF THE DRAWINGS

Exemplary embodiments of the disclosure are described herein with reference to the following drawings.

FIG. 1 is a flow diagram in accordance with the disclosed embodiments for geo-business localized social signals.

FIGS. 2A-2B are block diagrams in accordance with the disclosed embodiments for geo-business localized social signals.

FIGS. 3A-3E are block diagrams of components of data records in accordance with the disclosed embodiments for geo-business localized social signals.

FIG. 4 illustrates an example system of the disclosed embodiments for geo-business localized social signals.

FIG. 5 illustrates an example mobile device of the disclosed embodiments for geo-localized social signals.

FIG. 6 illustrates an example server of the disclosed embodiments for geo-localized social signals.

### DETAILED DESCRIPTION

Business pages of social websites represent a wide wealth of business directory information and social signal information that are applicable to a wide variety of additional applications. However, only a small-subset of business pages may be relevant or desired for use with some applications. For example, only businesses with physical locations may be relevant to some mapping and navigation applications. Over time, business pages may not be updated to reflect the closing of a business. A business page on a social website may linger, even if the business no longer exists. A business page on a social website may also fall out of use, if a new, separate business page is created. Business pages and user accounts may also be associated with businesses or groups that have physical locations that are inactive or dormant seasonally. A business may temporarily become in-active due to a store renovation, or other temporary closure. Some businesses, such as an individual's babysitting service may become inactive based on other fluctuating schedules of the individual (e.g., such as a babysitter's school schedule, vacation, or other job obligations). Inactivity or dormancy may occur irregularly or periodically. Entities may provide services at different geographic locations, and may move from one established physical location to another. There is thus a need to synthesize large amounts of continually changing business data information to identify relevant sub-sets of businesses from the available web based pages such as social media business pages. Relevance may include geographic business information as well as business category information. These characteristics may be referred to as “geo-business.” The term geo-business may include or other relevant characteristics allowing the identification of subsets of businesses. Relevance of the groups of businesses may be determined based on the ultimate end use of the identified information. Relevance of a business may further be based on popularity, quality, value, offers, and reviews appearing on the business pages of the social websites. These additional metrics of relevance can be determined based on social signals indicating changes in relevance over time.

Business entities having pages or user accounts with social websites are a desired set of directory information for commercial interests and for mapping and navigation operations. It is desirable to have a way to pick out businesses with various physical presence attributes, determine other characteristics of the business entities, and use social signals and other collected data from the social websites to categorize groups of business. It is further desirable to evaluate the social data and interactions with the businesses on the social websites to determine additional relevancy factors to provide a dynamic set of businesses (and accompanying information) for use with mapping and navigation applications. The output may have further applicability or adaptability with marketing applications, advertising applications, or for other purposes.

Social websites individually provide information for associated entities such as graphic geographic location, business categorization, and social signals. However, these information sources do not identify whether an entity's pages are associated with a real physical business and do not provide a dynamically defined set of physical businesses in their relevancy.

Specifically, in a mapping and navigation context, it is desirable to identify businesses with specific geographic locations. It is further desirable to limit instead of businesses based on popularity, public perception, use, and availability, and activity. These metrics of relevance, including specific geographic location and business type exhibit trends. These trends may further identify groups of businesses that would have utility in particular mapping context. It is further desirable to remove non-relevant businesses based on such information.

Individuals may use the social websites to obtain business directory information. The high volume of social content data requires automated mechanisms to select groups of relevant pages from amongst all available page information. The uncontrolled nature of changes, updates, entries and interactions of social websites provide further need for automated mechanisms to select groups of relevant pages from amongst all available page information. One goal of the disclosure is to provide self-configuring differential scoring mechanisms based on specific social signals against geo-business cell groups. An advantage of the system is self-adjustment based on the surrounding data.

Business page information from a social website may be accessed daily to build a historical trail of social signal changes over a period of time, such as a year. This historical trail of each individual business may be kept as a compounded record associated with each business page from the social website. Compound records for individual businesses along with current or daily new information from the social website may be grouped based on information contained in the social website records. Businesses may be grouped by multiple characteristics. For example, businesses may be organized into groups that are specific to a geographic area and a business type. For example, postal code and business category. In one example, all restaurants in a ZIP Code may be organized into one group or cell and multiple cells form a geo-business matrix. These groups of businesses in each cell may be further analyzed to determine dynamic relevance. By categorizing businesses based on geographic area and business type relevance may be determined in a manner that is geo-business localized. Examining these records as compounded for the determined business relevance provides analysis incorporating trend information. Multiple phases of analysis may be implemented. For example, averages and time decayed weighted averages may be determined for each cell by iterating over the list of compounded records in one phase. In another phase the social signals associated in the compounded records may be compared to the averages calculated in a previous phase to determine a delta score which may be positive or negative. Positive scores may indicate that this record has higher social interaction compared to business peers in the same geo-business cell.

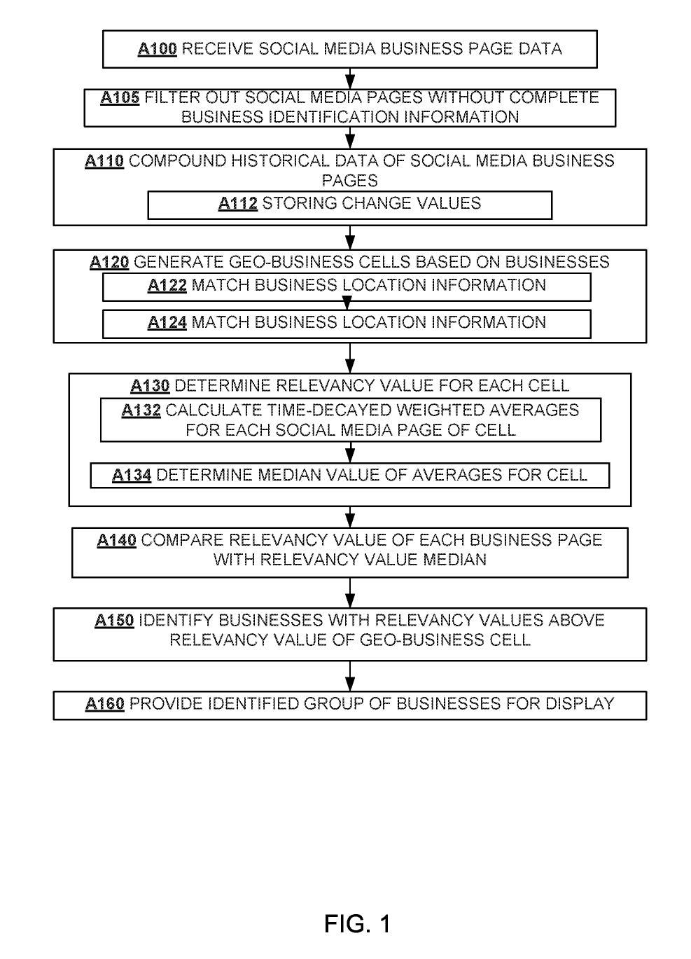

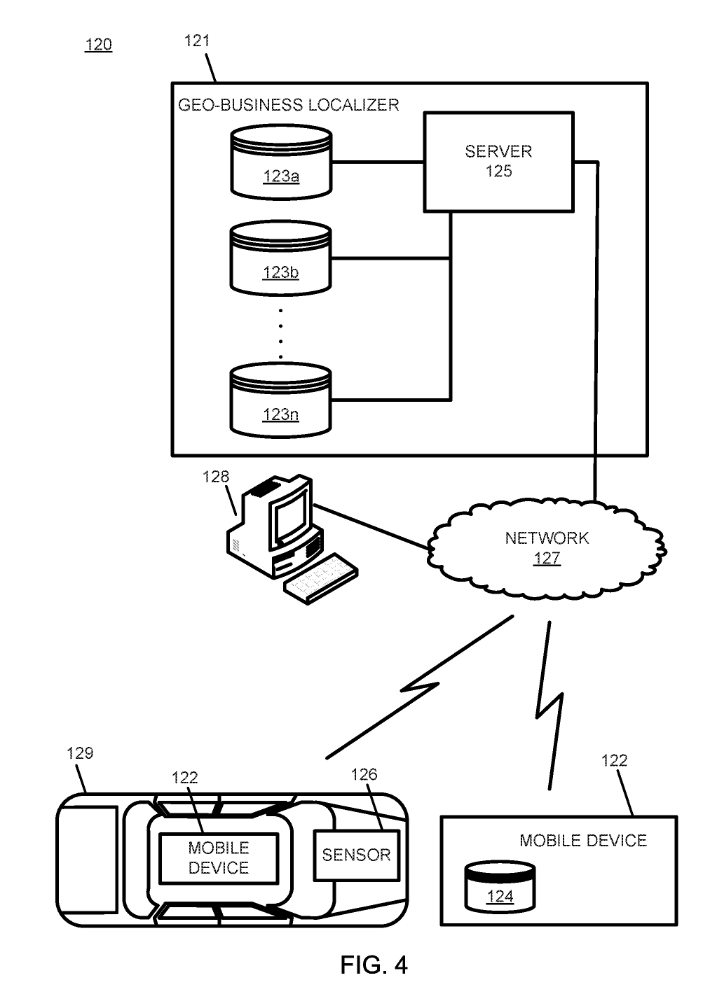

FIG. 1 is a flow chart of a method of the disclosed embodiments for geo-business localized social signals that may be performed by server 125 to dynamically identify businesses based on geo-business localized social signals. Acts are described with reference to the system and components depicted in FIGS. 4-6. Additional, different, or fewer acts may be provided. Acts may be performed in orders other than those presented herein.

In act A100, server 125 receives social media business page data. Each social media page is associated with a business. The received data may include business identification information and social signals associated with social media pages may be provided. Data may be received from social websites periodically. The duration of each may include any period of time such as daily, weekly, or monthly. Periodic receipt of social website data may be instantiated by a query from server 125 to servers associated with the social website or other servers storing data associated with the social website.

The social website may assign identification values to business or to the businesses page that are provided as part of business identification information in the received data. Identification value that is unique to each business page or maybe unique to each business account may be used as an identifier of the business for use with the disclosed embodiments. A social media page identification value may be appended to the received data based on this business location information.

In act A105, server 125 filters out received data associated with any social media page based on business identification information that includes both business location information and business category information.

In act A110, server 125 compounds historic data of social media business pages that have been received for each social media page based on the social signals associated with each respective social media page. In act A112, change values of social signals may be determined as a delta value for social signals associated with social media pages. A social signal may have a value associated with it based on a social signal type and the value of social signals associated with each social media page may be determined as an aggregated weighted value.

Historical data may be accumulated for each social media page and may be limited. The accumulated history may be limited based on a fixed number of periods. Accordingly, accumulated history may be representative of the most recent year of accumulated data based on data received daily by server 125. Alternatively, accumulated history may be representative of a fixed number of data entries such as the last 100 changes to each social media page. A fixed number of data entries may result in accumulated history data from one business spanning 100 days of daily changes. The same fixed number of data entries of accumulated history for another business may span multiple years indicating 100 days of changes to the social media page.

In act A120, server 125 generates a geo-business cells that include the social media pages that have associated business identification information. In act A122, geo-business cells may be generated based on matching business location information and matching business category information.

In act A130, server 125 determines the relevancy value of each geo-business cell based on the historical data for social signals of the business represented in each respective geo-business cell. All received social signals may be considered. One or more selected types of social signals may be considered.

A single type of social signal may be considered advantageously to identify a group of businesses exhibiting specific social trends. For example, only signals generated requiring a user to be in the same geographic location as the location of the business (e.g., checkins or ratings) may be considered for relevancy to identify businesses that have social relevance among a greater quantity of users. In another example, signals exhibiting a degree of affinity (e.g., ratings or repeated positive signals from the same user) may be considered for relevancy to identify businesses that may have social relevance along a smaller quantity of users but with strong degrees of affinity amongst users evaluating the business page or business.

Types of social signals considered or weights given to the relative value of one type of social signal over another may be pre-determined to more accurately identify trends among a range or demographic of users.

In act A132, a time decayed weighted average calculated for each geo-business cell. Compounded records for each social media page may store historical data including the social signals (e.g., checkins, likes, etc) values as a list of n pairs, in which each pair is given a value, V, and changed date, D. The relevancy value, R, may be defined for each social media page as the time decayed, weighted average, such as of Equation 1:

$$R = ( {\sum }_{i = 1}^{n} ( ( {V}_{i} - {V}_{i - 1} ) * \frac{\frac{{D}_{i} - {D}_{1}}{{D}_{n} - {D}_{1}}}{{D}_{i} - {D}_{i - 1}} ) ) / n \qquad Eq . 1$$

This relevancy value may be calculated for each social media page in each geo-business cell. The relevancy value for the entire geo-business cell may be defined as the median value of all the time decayed weighted averages the geo-business cell may be calculated as an act A134. Accordingly, each geo-business cell has a relevancy value that is sensitive to the dynamics of the group of businesses in each cell. For geo-business cells based on both a geographic region and type of business, the relevancy value is specific to one type of business within a geographic area.

In act A140, server 125 may compare the relevancy associated with individual social media pages of each geo-business cell to the relevancy value (e.g., median) of each respective geo-business cell. The relevancy value of the geo-business cell may be a threshold or may be used to calculate a range.

In act A150, server 125 may identify businesses having social media pages with relevancy values above the median relevancy value of the geo-business cell. Alternatively, the relevancy value may be used to determine a range from which to identify businesses. For example, businesses equal to, above, or within a predetermined range (such as a percent) of the relevancy value may be identified. A leniency factor between 0 and 1 may be pre-selected and applied to the relevancy to provide a threshold. In one non-limiting example, a leniency factor may be selected as 0.9 and multiplied with the median relevancy value, identifying business only business with a relevancy value greater than 0.9 times the median.

The group of identified businesses may skew results towards higher numbers of false negatives. Skewing relevancy thresholds may be changed to reduce false negatives or may be retained to advantageously provide highly selective identification of businesses within the group. A high level of selectivity may be advantageous and mapping applications including navigation applications, in order to display maps to determine which businesses to display that are relevant to the user or driver associated with mobile device 122.

Businesses that are identified provide the benefit of determining and isolating a highly selective group of businesses from the group of social website business pages several orders of magnitude larger. Without highly selective identification of businesses, mapping applications using social website business pages to determine points of interest for display may be overwhelmed by data points completely obscuring underlying map layers, rendering the map unusable. Basing selection on multiple criteria including geographic area and business type provide selection of businesses that can be tailored to a destination, route and/or current location associated with the mobile device 122. Further refining selection and relevance of businesses within the geo-business cells based on compounded historical social signal data dynamically updates the group of businesses with sensitivity to both temporary and long-term social website user trends. For example, the selected group of businesses is normalized for seasonal or geographically localized phenomena. For example, restaurants in a resort town may exhibit surges and lulls in business during a calendar year based on the season that are not exhibited by restaurants in a nearby and heavily populated city. Using the disclosed embodiments, a map can be populated with business information for successful and open local restaurants geographically located in the resort town regardless of whether the resort town is in high season or low season.

In act A160, the identified businesses may be provided for display on a mobile device 122. The identified businesses may be updated periodically so that the currently relevant group of businesses is provided for display includes the group of businesses having social media pages with relevancy values above the relevancy value (e.g., median relevancy value of the geo-business cell) of the geo-business cell based on the historical received data over the most recent number of periods.

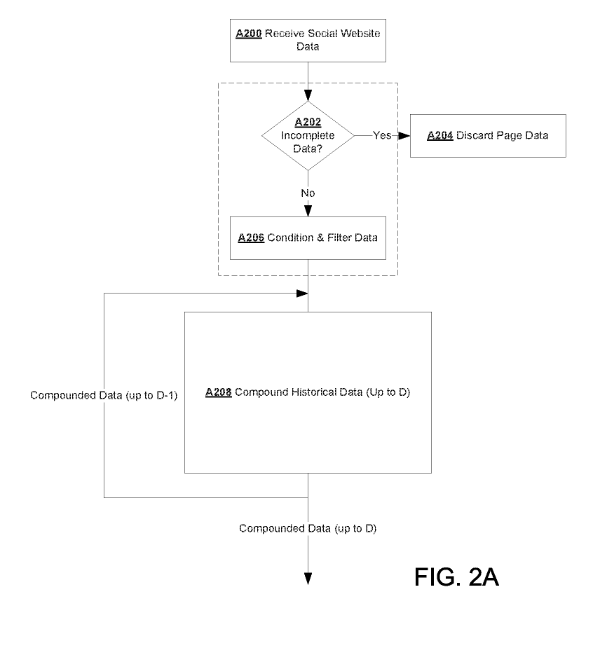

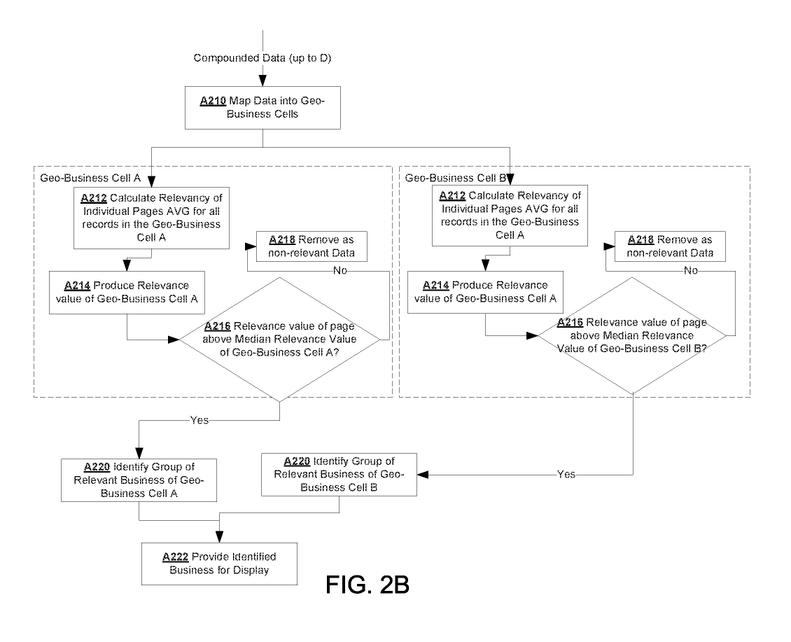

FIGS. 2A-2B are block diagrams in accordance with the disclosed embodiments for geo-business localized social signals. Blocks are described with reference to acts performed by the system and components depicted in FIGS. 4-6. Additional, different, or fewer acts may be provided. Acts may be performed in orders other than those presented herein. FIGS. 2A-2B may represent methods performed by the disclosed embodiments. The arrow identified “compounded data (up to D)” leading from the bottom of FIG. 2A represents the same flow of data entering the uppermost block A210 of FIG. 2B.

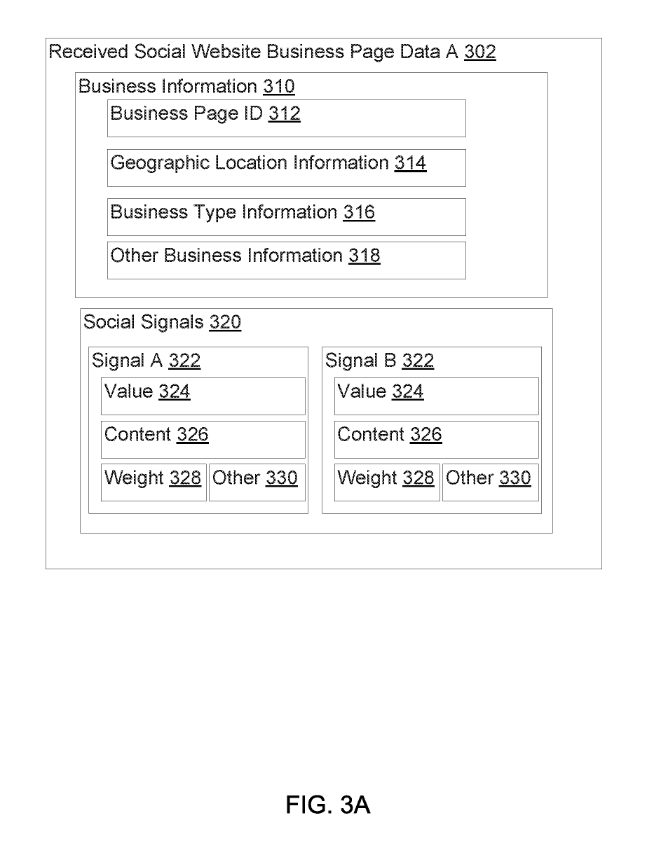

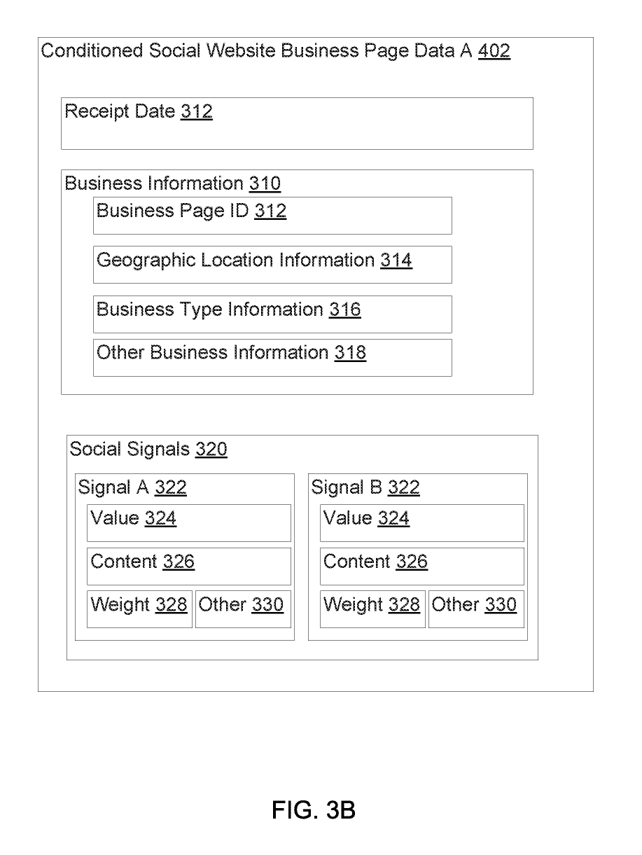

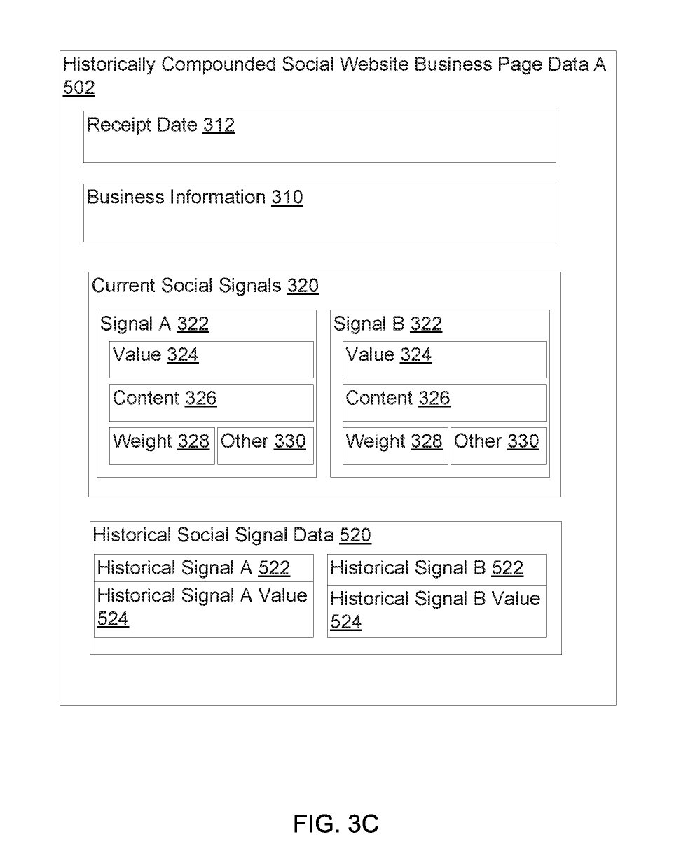

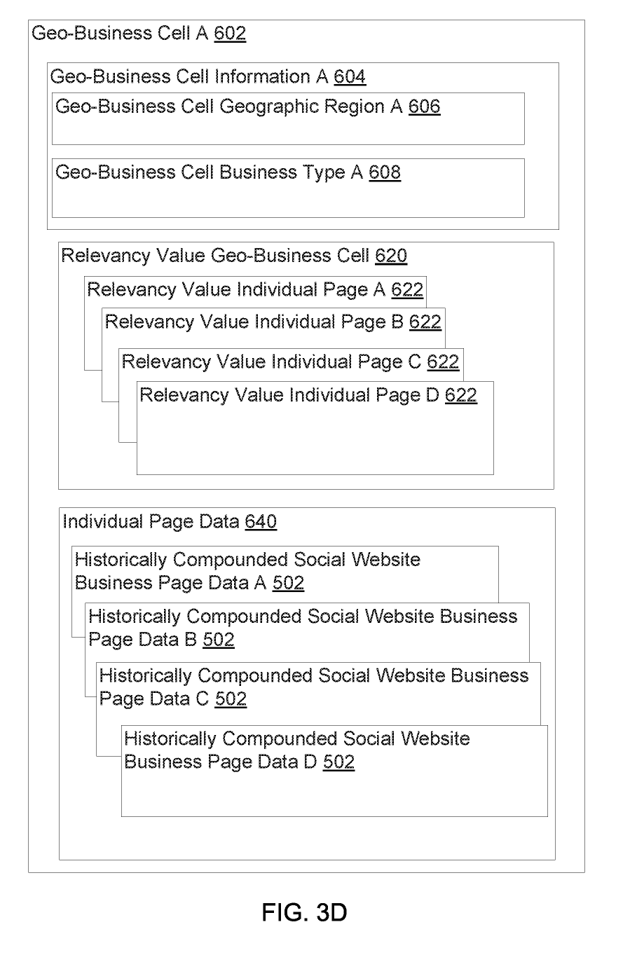

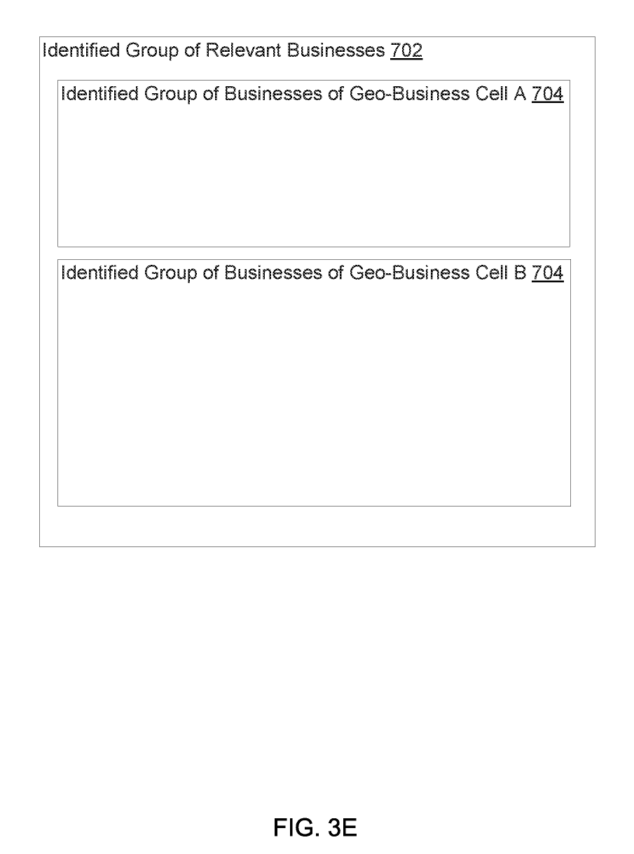

In block A200, social website data is received by server 125. As in block A202, it is determined whether individual business pages include complete data. Complete data may be predetermined and may indicate whether particular types of data records appear complete. For example, FIG. 3A illustrates a block diagram of a data record 302 of received social website business page A. Multiple data records 302 may be simultaneously received representing the business pages of a social website. Server 125 may query servers of social websites and receive data records 302 representative of the current social website business pages (e.g., at the time the query is received, or processed by the social website).

In block A202, server 125 may scan individual social website business pages to determine whether enough business information to effectively provide geo-business localized social signals is stored in the data record of the business page. By filtering incomplete data upon receipt, computational efficiency and data storage efficiencies are promoted. Accuracy of selectively identifying businesses that are currently operating is improved at this block because incomplete business pages are more likely to represent businesses that no longer exist.

In block A204, incomplete social website business pages may be discarded from further consideration in the processes of FIGS. 2A-2B. In some embodiments incomplete data constitutes business page data records missing either geographic location information or business type information. Incomplete data may include partial geographic location information and/or partial business type information. For example, a ZIP Code may constitute complete geographic location information. ZIP Codes including less than five digits may be considered an incomplete data record. An incomplete data record may be business page data containing a business type that is not recognized by server 125. The data record may be incomplete if the record is missing either geographic location information or business type information.

Complete data may constitute social website business pages containing business information that will be used to define geo-business cells. Alternatively, or additionally, complete data may include social website business pages that will be used to categorize the business page in one or more existing geo-business cells. Data records that are considered to be complete are then conditioned and filtered in block A206. Conditioning and filtering may be performed by processor 300 in order to efficiently store conditioned social website business page data records in databases 123a-n.

In block A208, historical data is compounded for each social website business page. Compounding historical data provides a representation of changes in social signals for each business page. Compounding historical data achieves efficient storage of social signal trends and values for a business page. Received social website data for business pages is representative of a business page at one point in time or one duration of time. Data may be received periodically to represent the business page at multiple points in time or over a duration of time. For example, social website data may be received periodically at intervals by the hour, one or more times daily, weekly, monthly and the like. Historical data may be compounded to be representative of the business page for a moving period or window of time. The window of time may represent multiple periods. For example, social website data received by server 125 daily may be compounded to provide a window of time representing the most recent year. That is, historical data for one social website business page is compounded, updated, and stored by server 125 representing the most recent 365 days. Each day, newly received social website data that is conditioned and filtered by server 125 may be compounded with the records received in last 364 days. Server 125 may discard data records older than one year for computational and storage efficiency. Accuracy of dynamic business identification may be increased based on the selected size of the window of time.

Continuing in FIG. 2B, compounded historical data associated with social website business pages are segregated and/or associated into geo-business cells in block A210. Segregating the compounded historical data into cells matches business pages that share similar business information advantageously the dynamic identification of groups of businesses from all the social website business pages. Geo-business cells may be generated by server 125 when new similarities are determined from received data from social websites. The geo-business cell may be characterized with business information associated with business pages. In one example, geo-business cells are characterized with a geographic region and a business type. That is, business pages within a geographic region that also share a common business type are categorized in separate geo-business cells. A business page may be associated to more than one geo-business cell.

Within each geo-business cell (illustrated as geo-business cells A and B), one or more relevance values may be determined in block A212. In some embodiments, a relevancy value is calculated as the average value of the set of historical social signals for each, individual business page. The average may be a time decayed average for the advantage of identifying groups of businesses over a long duration of time but valuing the relevance of more recent social signal data over older social signal data. A single relevance value representative of the geo-business cell may be determined in block A214. The single relevance value may represent the median value of all individual relevance averages in the geo-business cell. Alternatively, the relevance value of the geo-business cell may be determined as a time decayed average value of the social signals in each geo-business cell.

In block A216, relevance value of each individual pages is compared against the relevance value for the geo-business cell in order to identify businesses that exhibit high relevance with respect to businesses that have similar characteristics. Business pages with individual page relevance values below the relevance value of the geo-business cell may be removed from further consideration in block A218. In block A220, the group of relevant businesses with respect to its respective geo-business cell are identified. In block A222, identified, relevant businesses in one or more geo-business cell groups may be provided to a mapping application, navigation application, or other application of server 125 or mobile device 122. The group of identified businesses may provide instructions and/or data for businesses that will appear on a map associated with mobile device 122. Instructions and/or data may be provided from server 125 to mobile device 122 when are added or removed from the identified group. Groups of businesses may be provided based on geo-business cell characteristics selected by a user of mobile device 122. User selections may be inferred by processor 300 of server 125 based on start location, destination location, route information, search queries, current user location, and/or demographic information associated with the user of mobile device 122.

Blocks and acts represented in FIGS. 1 and 2A-2B may be repeated periodically and/or continuously to provide dynamically updated groups of businesses.

FIGS. 3A-3E are block diagrams of components of data records in accordance with the disclosed embodiments for geo-business localized social signals. These data records are described with respect to FIGS. 2A-2B and may also represent data records described with respect to the process illustrated in FIG. 1. These data records may be stored in databases 123a-n and/or among other components of the system represented in FIGS. 4-6. Data records illustrated in FIGS. 3A-3E may be formatted in any conceivable data format. One preferred format may be an official Internet media type such as JavaScript object notation (JSON).

The data received by server 125 in block A 200 of FIG. 2A may include multiple data records such as the received social website business page data A of data record 302 illustrated in FIG. 3A. Data record 302 may include business information data 310 and social signal data 320. Business information data 310 may include a business page ID 312. The business page ID 312 may be a unique value such as an alphanumeric number associated with the business page and/or business account of the social website. Business information 310 may include geographic location information 314. Geographic location information 314 may include designation of a geographic region (e.g., city, state, ZIP Code, ZIP+4, area code, neighborhood, country, etc.) and/or a specific geographic location (e.g., address, latitude/longitude, etc.). Business type information 316 may include one or more business category or type (e.g., dining, restaurant, cuisine, services, babysitter, toddlers). Business information 310 may include other business information 318. Some components of business information 310 may be determined by the social website, such as the business page ID 312. Some components of business information 310 may be entered by social website users and/or the business associated directly with the business page, such as geographic location information 314 and business type information 316. Some components of business information 310 may include both information determined by the social website as well as information entered by a user. Business information 310 may include other business information 318.

Conditioned social website business page data records 402, illustrated in FIG. 3B, may be generated based on raw data received from social websites such as data records 302 of FIG. 3A. Conditioned and filtered data records 402 may be generated by processor 300 and stored in databases 123a-n. Data record 402, representing condition social website business page A, may include a receipt date 312, business information 310, social signals 320, and/or other data. Receipt date 312 represents the date and/or time that corresponding data record 302 was received by server 125. Business information 310 and social signals 320 may represent some or all of correspondingly numbered information of FIG. 3A. Conditioned social website data records 402 may be stored in a format differing from the format of the received data record 302. Data objects within data record 402 may be created based on existing from the social website.

Social signal data 320 of data record 302 may include data associated with multiple types of social signals 322 (illustrated as social signal A and social signal B). The received types of social signals may change over time. Information specific to the type of social signal 322 may be further provided such as a value 324, content 326, weight 328, or other data 330. The value 324 of the social signal may refer to the number of signals received by the business page. The content 326 of the social signal may refer to the content of an individual signal, such as the text of a user review. Weight 328 may be a value associated with each signal 322 indicating the weight of the social signal with respect to all types of social signals.

Social signals may include likes, shares, followers, mentions of the business name, links to the business page where the businesses website, users associated with the business page or other numbers quantifying social signals. Social signals may be positive or negative. Additional social signals may include specific content such as a review or rating. Social signals may be derived from any interaction of users of the social website such as a clickstream.

Historically compounded records 502 social website business page A of FIG. 3C may be compounded from conditioned social website business page data records 402 illustrated in FIG. 3B. Historically compounded records 502 may be generated by processor 300 and stored in big databases 123a-n of server 125 as discussed with respect to block A208 of FIG. 2A. Data records 502 may include receipt date 312, business information 310, current social signals 520. Receipt date 312, business information 310 and social signals 320 may represent some or all of correspondingly numbered information of FIGS. 3A-3B. Historical social signal data 520 may include compounded historical social signal compounded individually for different types of social signals 522 (illustrated as Signal A and Signal B). Individual historical values may be compounded as data record 524 for each type of social signal 522. Historical social signal data 520 may include a weighted average of historical signal values 524. This average may be weighted based on the type of social signal. Historical social signal data may be compounded using other known methods. Historically compounded data records 502 may include copies of conditioned social website business page data records 402 for each period represented in the window of time. More efficiently, server 125 may compress historical data records 502 by storing only changes associated with the social signals over time. The quantity of change (e.g., delta value) may be determined and stored as part of or all of the compounded historical signal data of one or more social signals. Even more efficiently, social signal data 520 may be represented by storing receipt dates 312 and delta values and/or social signal values 524 for only those periods in which the social signal exhibits change (i.e., a delta value other than zero). For example, if a new business page receives one social signal the day the business page is created but does not receive another social signal for one month, social signal data 520 may not include data specific to the intervening days.

Geo-business cell data records 602 for geo-business cell A are illustrated in FIG. 3D. Historically compounded records 502 may be associated with one or more geo-business cells 602 based on geo-business cell information 604. Geo-business cell information 604 may include geo-business cell geographic region information 606 and geo-business cell business type 608. Geo-business cell 602 may further include relevancy value geo-business cell 620 and individual page data 640. Relevancy value geo-business cell 620 may include an individual relevancy value for each individual business page 622 that has been associated with the geo-business cell (e.g., pages A-D). Individual page data 640 may include historically compounded social website business page data 502 for each page that has been associated with the geo-business cell (e.g., pages A-D). Historically compounded data 502 may correspond to a portion of, or all of, data records 502 for each business page as illustrated in FIG. 3C.

Data records 702 identifying one or more groups of relevant businesses are illustrated in FIG. 3E. Data records 702 may include data records 704 identifying a group of businesses in one geo-business cell (illustrated as geo-business cell A and B). Data records 702 and 704 may include a portion of geo-business cell information or business page data records depicted in FIGS. 3A-3D. Data records 702 may be stored in databases associated with server 125 or may be provided to mobile device 122 for use with navigation or map based mobile applications. Data records 702 and 704 may be updated periodically and/or continuously to provide relevant business information based on the most recently received social website data records.

FIG. 4 illustrates one example system 120 for dynamic business identification with geo-business localized social signals. The system 120 includes geo-business localizer 121, one or more mobile devices 122 (navigation devices), a workstation 128, and a network 127. The system may further include a vehicle 129 including a mobile device 122 and a sensor 126. Additional, different, or fewer components may be provided. For example, many mobile devices 122 and/or workstations 128 connect with the network 127. The geo-business localizer 121 includes a server 125 and one or more databases. The server 125 may maintain multiple databases 123a, 123b . . . 123n. The term database and refers to a set of data stored in a storage medium and may not necessarily reflect specific any requirements as to the relational organization of the data. The term “server” is used herein to collectively include the computing devices at the geo-business localizer 121 for creating, maintaining, and updating the multiple databases 123a-123n. Any computing device may be substituted for the mobile device 122. The computing device may be a host for a website or web service such as a mapping service or a navigation service. A mapping service may provide maps generated from the databases 123a-123n using geo-business localized social signal information, and the navigation service may calculate routing or other directions from the geographic data and geo-business localized social signal information of the databases 123a-123n.

Mobile device 122 and/or vehicle 129 may include processors and databases providing some or all of the services provided by geo-business localizer 121. Geo-business localizer 121 of mobile device 122 may operate in tandem with remote geo-business localizer 121 via network 127. As described herein, processing of social website data, identification of businesses, mapping or navigation information may occur as described with reference to geo-business localizer 121 and additionally, alternatively, or jointly may be performed by geo-business localizers disposed in or integral with mobile device 122 and/or vehicle 129.

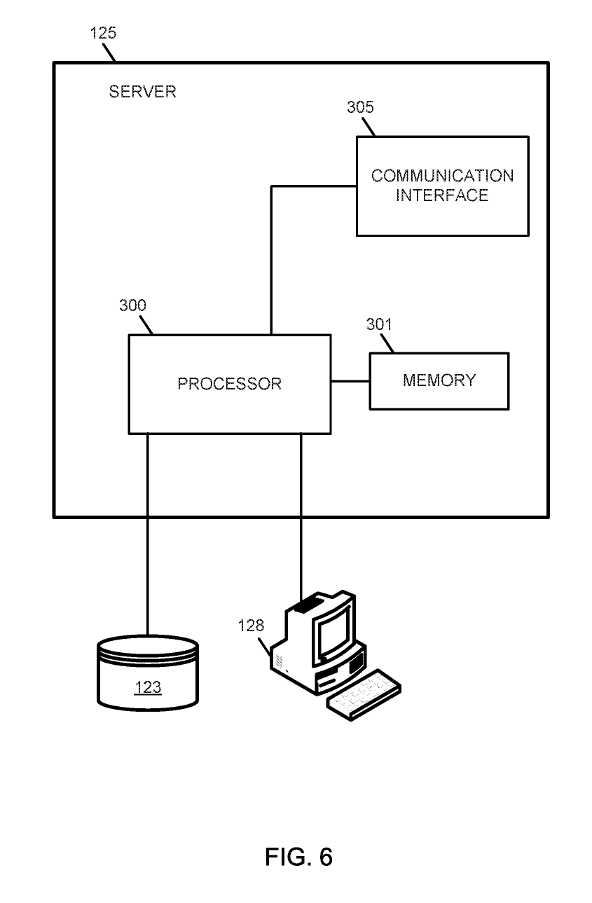

The databases 123a-123n may include social website feed databases, compounded historical social website feed databases, information generated from or used with social website feed databases, navigation and mapping information, road imagery including street level images, point cloud data, and/or existing map data. As shown in FIG. 6, a master copy of the database 123a may be stored at the geo-business localizer 121, and the databases 123b-n may include alternative versions or past versions of information associated with identified groups of businesses based on geo-business localized social signals. The master copy of the database 123a may be the most current or up to date copy of the database. In addition, the mobile device 122 may store a local copy of the database 124. In one example, the local copy of the database 123b is a full copy of the database, and in another example, the local copy of the database 124 may be a cached or partial portion of the database.

The local copy of the database 124 located on mobile device 122 may include data from various versions of the database 123a-123n. The cached portion may be defined based on a geographic location of the mobile device 122 or a user selection made at the mobile device 122. The server 125 may send dynamically identified business group information, mapping information, and/or navigation information to the mobile device 122.

The mobile device 122 may be a personal navigation device (PND), a portable navigation device smart phone, a mobile phone, a personal digital assistant (PDA), a car, a tablet computer, a notebook computer, and/or any other known or later developed connected device or personal computer. Non-limiting embodiments of navigation devices may also include relational database service devices, mobile phone devices, or car navigation devices. The vehicle 129 with mobile device 122 and sensor 126 may be an autonomous driving vehicle, a data acquisition vehicle, or a vehicle equipped with navigation or other communication capabilities.

The geo-business localizer 121, the workstation 128, the mobile device 122, and vehicle 129 are coupled with the network 127. The phrase “coupled with” is defined to mean directly connected to or indirectly connected through one or more intermediate components. Such intermediate components may include hardware and/or software-based components.

The network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

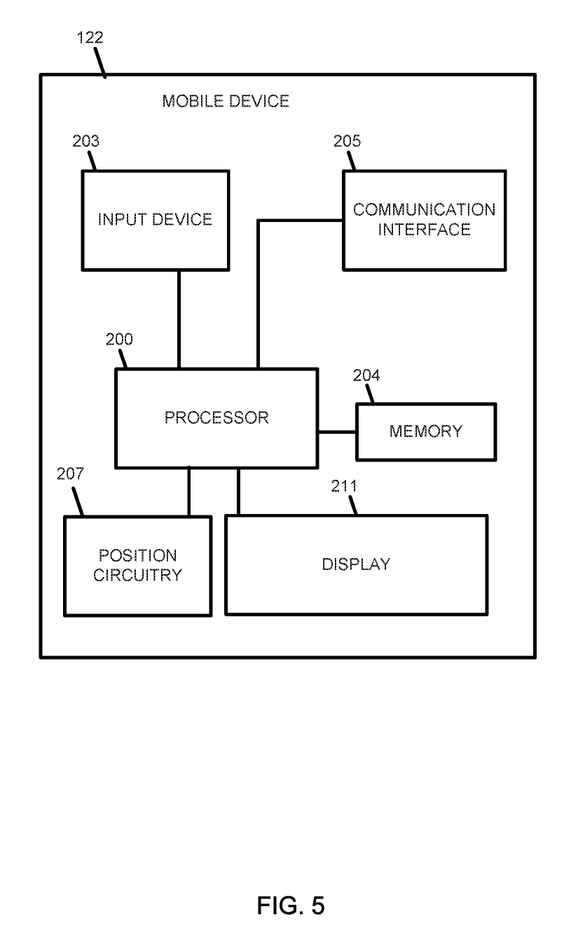

FIG. 5 illustrates an exemplary mobile device 122 of the system of FIG. 4. The mobile device 122 includes a processor 200, a memory 204, an input device 203, a communication interface 205, position circuitry 207, and a display 211. Additional, different, or fewer components are possible for the mobile device 122. FIGS. 1-2 illustrate example flow diagrams for the operation of mobile device 122 and processor 200. Additional, different, or fewer acts may be provided.

The positioning circuitry 207 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 207 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer built or embedded into or within the interior of the mobile device 122. The accelerometer is operable to detect, recognize, or measure the rate of change of translational and/or rotational movement of the mobile device 122. The mobile device 122 receives location data from the positioning system. The location data indicates the location of the mobile device 122.

The input device 203 may be one or more buttons, keypad, keyboard, mouse, stylist pen, trackball, rocker switch, touch pad, voice recognition circuit, or other device or component for inputting data to the mobile device 100. The input device 203 and the display 211 may be combined as a touch screen, which may be capacitive or resistive. The display 211 may be a liquid crystal display (LCD) panel, light emitting diode (LED) screen, thin film transistor screen, or another type of display.

The processor 200 and/or processor 300 may include a general processor, digital signal processor, an application specific integrated circuit (ASIC), field programmable gate array (FPGA), analog circuit, digital circuit, combinations thereof, or other now known or later developed processor. The processor 200 and/or processor 300 may be a single device or combinations of devices, such as associated with a network, distributed processing, or cloud computing. The processor 200 and/or processor 300 may include a navigation and/or route personalization generator. Mobile device 122 may receive and store dynamically updated business identification information, map information, and navigation information along with metadata associated with these types of information. Processor 200 may receive updated business identification information via network 127 and generate a route from a starting point to a destination point based on the received business information. Processor 200 may perform all route generation and map generation on mobile device 122. That is, mobile device 122 may business identification information via network 127 identifying relevant business information, map information, navigation information, and other information via network 127. Processor 200 of mobile device 122 may populate or generate a map based on the received information. Processor 200 of mobile device 122 may additionally receive information associated with vehicle 129 and its ground truth, i.e., actual sensor information associated with the current location and surroundings of vehicle 129. Processor 200 of mobile device 122 may work in tandem with server 125 via network 127 to perform some or all of the dynamic business identification.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 301 may be removable from the mobile device 122, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

The mobile device 122 may be configured to execute mapping algorithms to determine an optimum route to travel along a road network from an origin location/starting point to a destination location/destination point in a geographic region that may use maps including large scale scan information. Mobile device 122 may be configured to acquire imagery or other data along with geolocation and pose information. Using input from the end user, the navigation device 122 may examine potential routes between the origin location and the destination location to determine the optimum route. The navigation device 122 may then provide the end user with business information along the optimum route along with navigation instructions. Some navigation devices 122 show detailed maps on displays outlining the businesses along the route, information associated with the businesses, locations of certain types of features, and so on.

FIG. 6 illustrates an example server 125. The server 125 includes a processor 300, a communication interface 305, and a memory 301. The server 125 may be coupled to one or more databases 123 and a workstation 128. The workstation 128 may be used to request social website data from another source or enter social website data. The workstation 129 may be used to enter parameters, thresholds, and values associated with defining relevance characteristics for a specific group of businesses. The databases 123 may include information entered from workstation 128. Additional, different, or fewer components may be provided in the server 125. FIGS. 1-2 illustrate example flow diagrams for the operation of server 125. Additional, different, or fewer acts may be provided.

The processor 300 and/or processor 200 may include a general processor, digital signal processor, ASIC, FPGA, analog circuit, digital circuit, combinations thereof, or other now known or later developed processor. The processor 300 and/or processor 200 may be a single device or combinations of devices, such as associated with a network, distributed processing, or cloud computing. The processor 300 and/or processor 200 perform operations associated with the geo-business localizer. Server 125 may receive and store compounded historical social website feed databases, information generated from or used with social website feed databases, navigation and mapping information, road imagery including street level images, point cloud data, and/or existing map data, and metadata associated with these types of information. Processor 300 may receive starting relevance information defining a desired group of businesses for identification from mobile device 122 via network 127 and determine a dynamically identified group of businesses, compounded historical social website feed databases, information generated from or used with social website feed databases, navigation and mapping information, road imagery including street level images, point cloud data, and/or existing map data, and metadata associated with the information. Processor 300 may perform all analysis and determination of business identification based on geo-business localization of social signals at server 125. That is, server 125 may social website feed information, relevance parameters from mobile device 122 or other sources via network 127 and dynamically identify groups of business information. Processor 300 of server 125 may calculate determine and update groups of businesses, generate maps, and generate navigation information based on the received information. Processor 300 of server 125 may additionally receive information associated with vehicle 129 and its ground truth, i.e., actual travel time an actual route information associated with the trip and/or information associated with sensors 126. Processor 200 of mobile device 122 may work in tandem with processor 300 and server 125 via network 127 to perform some or all of the identification of businesses based on geo-business localized social signals.

The memory 301 and/or memory 204 may be a volatile memory or a non-volatile memory. The memory 301 and/or memory 204 may include one or more of a read only memory (ROM), random access memory (RAM), a flash memory, an electronic erasable program read only memory (EEPROM), or other type of memory.

The communication interface 305 and/or communication interface 205 may include any operable connection. An operable connection may be one in which signals, physical communications, and/or logical communications may be sent and/or received. An operable connection may include a physical interface, an electrical interface, and/or a data interface. The communication interface 305 and/or communication interface 205 provides for wireless and/or wired communications in any now known or later developed format.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes, acts, and logic flows described in this specification can be performed by one or more programmable processors executing one or more computer programs to perform functions by operating on input data and generating output. The processes, acts, and logic flows can also be performed by, and apparatus can also be implemented as, special purpose logic circuitry, e.g., an FPGA or an ASIC.

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and any one or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or is operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a vehicle, a navigation device, a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method of identifying businesses based on geo-business localized signals, the method comprising:
receiving data indicative of a plurality of web based pages, wherein each web based page is associated with a business, wherein received data includes social signals associated with respective web based pages and business identification information;
compounding historical received data for each social media page based on the social signals associated with the respective social media page;
generating a plurality of geo-business cells comprising social media pages with associated business identification information;
determining a relevancy value of each geo-business cell based on the historical data for web based pages of each respective geo-business cell;
comparing a relevancy value associated with individual web based pages of each geo-business cell to the relevancy value of each respective geo-business cell; and
identifying businesses having web based pages with relevance values above the relevancy value of the geo-business cell.

2. The method of claim 1, wherein determining the relevancy value of each geo-business cell group further comprises:
calculating a time-decayed weighted average for each web based page of each geo-business cell.

3. The method of claim 1, wherein determining the relevancy value of each geo-business cell group further comprises:
calculating a median value of time-decayed weighted averages for each geo-business cell.

4. The method of claim 1, further comprising:
filtering received data associated with any web based page based on business identification information comprising business location information and business category information.

5. The method of claim 1, wherein generating the plurality of geo-business cells based on business identification information further comprises:
matching business location information; and
matching business category information.

6. The method of claim 1, further comprising:
appending a social media page identification value to the received data based on the business identification information.

7. The method of claim 1, wherein the received data is received periodically.

8. The method of claim 7, wherein compounding historical received data for each web based page based on the social signals associated with the respective web based page further comprises:
storing a delta value when a changed value of social signals associated with a web based page is received.

9. The method of claim 1 further comprising:
weighting a value of social signals associated based on a social signal type; and
determining the value of social signals associated with each web based page as an aggregated weighted value.

10. The method of claim 7, wherein a duration of each period is one of daily, weekly, or monthly.

11. The method of claim 7, wherein compounding historical received data comprises:
accumulating historical received data for each web based page for received data for a most recent fixed number of periods.

12. A method of providing dynamically updated business mapping based on geo-business localized social signals, the method comprising:
periodically receiving data indicative of a plurality of web based pages, wherein each web based page is associated with a business, wherein received data includes social signals associated with respective web based pages and business identification information;
compounding historical received data for each web based page based on the social signals associated with the respective web based page within a most recent number of periods;
generating a plurality of geo-business cells comprising web based pages with associated business identification information;
determining a relevancy value of each geo-business cell based on the historical data for web based pages of each respective geo-business cell;
comparing a relevancy value of social signals associated with each web based page of each geo-business cell to the relevancy value of each respective geo-business cell;
identifying a currently relevant group of businesses having web based pages with relevancy values above the relevancy value of the geo-business cell based on the historical received data over the most recent number of periods; and
providing the currently relevant group of businesses for display on a map.

13. The method of claim 12, wherein determining the relevancy value of each geo-business cell group further comprises:
calculating a time-decayed weighted average for each web based page of each geo-business cell.

14. The method of claim 13, wherein determining the relevancy value of each geo-business cell group further comprises:
calculating a median value of time-decayed weighted median value for each geo-business cell.

15. The method of claim 12, further comprising:
filtering received data associated with any web based page based on business identification information comprising both business location information and business category information.

16. The method of claim 15, wherein generating the plurality of geo-business cells based on business identification information further comprises:
matching business location information; and
matching business category information.

17. The method of claim 12, further comprising:
appending a web based page identification value to the received data based on the business identification information.

18. An apparatus for identifying businesses based on geo-business localized social signals, the apparatus comprising:
at least one processor; and
at least one memory including computer program code for one or more programs; the at least one memory and the computer program code configured to, with the at least one processor, cause the apparatus to at least perform:
periodically receive data indicative of a plurality of web based pages, wherein each web based page is associated with a business, wherein received data includes social signals associated with respective web based pages and business identification information;
filter received data associated with any web based page based on business identification information comprising both business location information and business category information;
compound historical received data for each web based page based on the social signals associated with the respective web based page within a most recent number of periods;
generate a plurality of geo-business cells comprising web based pages with matching business location information and matching business category information;
determine a relevancy value of each geo-business cell based on the historical data for web based pages of each respective geo-business cell;
compare a relevancy value of social signals associated with each web based page of each geo-business cell to the relevancy value of each respective geo-business cell;
identify a currently relevant group of businesses having web based pages with relevancy values above the relevancy value of the geo-business cell based on the historical received data over the most recent number of periods; and
provide the currently relevant group of businesses for display on a map.

19. The apparatus of claim 18, wherein the relevancy value of each geo-business cell group is determined by further causing the apparatus to at least perform:
calculate a time-decayed weighted average for each web based page of geo-business cell.

20. The apparatus of claim 19, wherein the relevancy value of each geo-business cell group is determined by further causing the apparatus to at least perform:
calculate a median value of time-decayed weighted values for each geo-business cell.
